(19) United States
(12) Patent Application Publication
(10) Pub. No.: US 2026/0317996 A1
(43) Pub. Date: Oct. 15, 2026

(54) APPLE-BASED LEATHER PRODUCTION METHOD

(71) Applicant: FLAURA, CUIR VEGETAL INC., Québec (CA)

(72) Inventors: Fannie LAROCHE, Québec (CA); Grégory HERSANT, Québec (CA); Ahmad IBRAHIM, Québec (CA)

(21) Appl. No.: 19/491,507

(22) PCT Filed: Jun. 7, 2024
(86) PCT No.: PCT/CA2024/050761

§ 371 Date: Dec. 9, 2025

Related U.S. Application Data
(60) Provisional application No. 63/507,292, filed on Jun. 9, 2023.

(51) Int. Cl. D06N 3/00; C08K 5/00; C08K 11/00

(52) U.S. Cl. CPC D06N 3/0061; C08K 5/00; C08K 11/00; D06N 3/0079; D06N 2205/10

(57) ABSTRACT

There is provided a method of producing an apple-based synthetic leather. The method generally has the steps of: obtaining a mixture including an apple-based residue, and a polymer agent, the mixture having from 30 to 50 wt. % of the apple-based residue; forming the mixture into a desired shape; and drying the desired shape to obtain the synthetic leather.

### CROSS-REFERENCE TO A RELATED APPLICATION

This disclosure claims priority from U.S. Provisional Application No. 63/507,292 filed on Jun. 9, 2023, which is incorporated herein by reference in its entirety.

### TECHNICAL FIELD

This disclosure relates to the field of artificial leather production, particularly leather produced from food sources such as apples.

### BACKGROUND OF THE ART

The production of leather from animal skin is no longer sustainable nor socially acceptable. Indeed, artificial leather is now the most common leather sold on the market and animal derived leather is only a rarity. Traditionally, artificial or synthetic leather is produced with polymers derived from the petroleum industry which has a significant carbon footprint and environmental impact. These traditional polymers include polyurethane (PU) and polyvinyl chloride (PVC). However, the synthetic leather industry has struggled to transition to greener alternatives. Food, vegetables and other naturally occurring sources of cellulose or biopolymers have been used to produce leather but they have been combined with the traditional polymers PU and PVC. Generally limited amounts of food derived biopolymers were successfully included in the leather and the remaining polymer content is still petroleum based polymers. Therefore, although the resulting leather has a better carbon footprint than a pure or high content (>80%) PU or PVC leather there is still room for improvement. It would be desirable to produce a synthetic leather with minimal or no inclusion of petroleum based polymers while maintaining desirable flexibility and resistance properties.

### SUMMARY

In accordance with a first aspect of the present disclosure, there is provided a method of producing a synthetic leather, the method comprising: obtaining a mixture including an apple-based residue, and a polymer agent, the mixture having from 30 to 50 wt. % of the apple-based residue; forming the mixture into a desired shape; and drying the desired shape to obtain the synthetic leather.

Further in accordance with the first aspect of the present disclosure, the apple-based residue can for example be in powder form or be an apple paste.

Further in accordance with the first aspect of the present disclosure, the method can for example further comprise, before obtaining the mixture, heat treating the apple-based residue to pasteurize the apple-based residue.

Still further in accordance with the first aspect of the present disclosure, the method can for example further comprise, before the heat treating, grinding apples to produce an apple-based residue.

Still further in accordance with the first aspect of the present disclosure, grinding the apples can for example comprise separating apple flesh from apple peel, and grinding the apple peel to form the apple-based residue.

Still further in accordance with the first aspect of the present disclosure, the apple peel can for example be grinded without prior dehydration.

Still further in accordance with the first aspect of the present disclosure, the polymer agent can for example be selected from polyvinyl alcohol (PVA), polylactic acid (PLA), polyhydroxybutyrate (PHB), polyhydroxyalkanoate (PHA), biodegradable polyester and derivatives thereof.

Still further in accordance with the first aspect of the present disclosure, the apple-based residue can for example have particles of a size of less than 100 μm.

Still further in accordance with the first aspect of the present disclosure, the mixture can for example include from 35 to 45 wt. % of the apple-based residue.

Still further in accordance with the first aspect of the present disclosure, the mixture can for example include from 25 to 70 wt. % of the polymer agent.

Still further in accordance with the first aspect of the present disclosure, the mixture can for example include up to 30 wt. % of a plasticizing agent.

Still further in accordance with the first aspect of the present disclosure, the plasticizing agent can for example be selected from the group consisting of glycerol, polyglycerol, starch, and isosorbide.

Still further in accordance with the first aspect of the present disclosure, said forming can for example include extruding the mixture into the desired shape. The extrusion can optionally comprise a first step of producing granules and a second step of melting and extruding the granules into the desired shape.

Still further in accordance with the first aspect of the present disclosure, the mixture can for example further include a coloring pigment.

Still further in accordance with the first aspect of the present disclosure, the drying can for example be performed at a temperature ranging from 45 to 65° C.

Still further in accordance with the first aspect of the present disclosure, the drying can for example be performed under one of suction and vacuum.

Still further in accordance with the first aspect of the present disclosure, the heat treating can for example be performed at a temperature ranging from 60 to 70° C.

Still further in accordance with the first aspect of the present disclosure, the mixture can for example be free of at least one of polyurethane and polyvinyl chloride.

Still further in accordance with the first aspect of the present disclosure, the method can for example further comprise treating a surface of the synthetic leather with an elastomeric additive.

Still further in accordance with the first aspect of the present disclosure, the mixture can for example further include anti-ultraviolet additives.

Still further in accordance with the first aspect of the present disclosure, the desired shape is for example a free standing sheet.

Still further in accordance with the first aspect of the present disclosure, the synthetic leather is for example a sheet having a thickness of from 150 μm to 1 mm.

Still further in accordance with the first aspect of the present disclosure, the synthetic leather is for example produced on a base layer.

In accordance with a second aspect of the present disclosure, there is provided a mixture to be used for preparing artificial leather comprising from 30 to 50 wt. % of apple-based residue, from 25 to 70 wt. % of a polymer agent, up to 10 wt. % of a coloring pigment and up to 30 wt. % of a plasticizing agent.

Many further features and combinations thereof concerning the present improvements will appear to those skilled in the art following a reading of the instant disclosure.

### DESCRIPTION OF THE DRAWINGS

FIG. 1 is a photograph of an example sample of synthetic leather obtained by the method according to the present disclosure;

FIG. 2 is a flow chart of a method of producing a synthetic leather from an apple paste, in accordance with one or more embodiments;

FIG. 3 is a schematic of a system for producing a synthetic leather by extrusion followed by lamination;

FIG. 4 is a graph showing the particle size distribution of apple-based residue before and after grinding; and

FIG. 5 is an image showing a leather roll of synthetic leather from an apple paste in accordance with one embodiment.

### DETAILED DESCRIPTION

The present disclosure provides a method of producing synthetic leather also referred to as “faux leather” using apple-based products. The synthetic leather is preferably a sustainable and biodegradable leather that is made without any petroleum derived polymers such as PU and PVC. In some embodiments, the synthetic leather contains less than 0.1 wt. % of PU and PVC, and in some cases can be free of PU and PVC. The synthetic leather of the present disclosure is made from polymers derived from the apple (cellulose and its derivatives) as well as polymer agent additions including, but not limited to, polyvinyl alcohol (PVA), polylactic acid (PLA), polyhydroxybutyrate (PHB), polyhydroxyalkanoate (PHA), and biodegradable polyester such as Terratex™ FX1515, to name a few examples. Also encompassed herein are derivatives of the polymers described, such as a PLA derivative. A biodegradable polyester as encompassed herein refers to a polyester that was modified to be biodegradable. This can be done by chemical modification or the formation of a blend of polymers. In one example of a blend, around 25 wt. % of the polymers can be natural biodegradable polymers and the remaining 75 wt. % polyester. Accordingly, the polymer agent is preferably a biodegradable polymer or a biopolymer. In some embodiments, particularly when a coating method is used, the polymer agent is hydrosoluble and may be provided as a suspension for example an emulsion of PLA or a derivative thereof. The polymer agent added is preferably PVA because PVA is biodegradable, hydrosoluble and has reactive OH group that can crosslink with cellulose. To solubilize a polymer in an aqueous solution, the following steps can be performed: a) adding apple based residue (e.g. in powder form) to the aqueous solution at ambient temperature or less, b) heating the aqueous solution to solubilize the polymer (e.g. PVA at a temperature of 90-98° C.), and c) mixing the aqueous solution until the polymer (e.g. PVA) is completely solubilized. Step c) can take more or less time depending on the solubility of the polymer and efficacy of the mixing.

The polymer agent can be considered herein as having the role of a binder in the mixture. The polymer agent can be considered as the balance in the mixture (i.e., all the other components are added in their specified wt. % and the polymer agent is added to complete the mixture to 100%). In some embodiments, the polymer agent is present in a concentration of from 25 to 70 wt. %, from 30 to 70 wt. %, from 35 to 70 wt. %, from 40 to 70 wt. %, from 45 to 70 wt. %, 50 to 70 wt. %, from 55 to 70 wt. %, or from 60 to 70 wt. % of the mixture.

To produce the synthetic leather, a mixture is provided which includes an apple-based residue, a polymer agent, and optionally a plasticizing agent. This mixture includes from 30 to 50 wt. %, 35 to 50 wt. %, from 35 to 45 wt. %, from 35 to 40 wt. %, from 40 to 50 wt. % or from 40 to 45 wt. % of apple paste. It was observed that at concentrations above 50 wt. % of the apple paste the synthetic leather did not have adequate mechanical properties and durability for use in the textile and other industries. The synthetic leather obtained with more than 50 wt. % of apple paste was fragile, susceptible to breaking and had low malleability/flexibility. A minimum 30 wt. %, preferably 35 wt. %, more preferably 40 wt. % of apple paste allows to reduce the cost of the process because less polymer agent would be needed. Moreover, the higher the concentration of apple paste, the higher the sustainability and waste recycling capacity of the process.

In some embodiments, the apple-based residue is defined as comprising, consisting essentially of, or consisting of waste residue obtained from processing apples or waste apples themselves. The apple based residue can contain the entirety of an apple (i.e. peel, seeds, pulp and stem) or at least a portion of the apple (i.e. one or more of the peel, seeds, pulp and stem). The apple based residue can be in a dry powder form. The dry powder of apple based residue may be derived from at least a portion of the apple, preferably the apple peel. The term “apple paste” as used herein is understood to mean a semi-liquid colloidal suspension, emulsion or aggregation comprising comminuted apples. In some embodiments, the liquid phase in the apple paste is solely provided from the apples' own water content. In other embodiments, water may be added during the grinding performed to obtain the apple paste. When operating with apples it is preferred to perform a pasteurization on the apple paste before adding the apple paste in the mixture. One exemplary pasteurization method is a heat treatment for at least 30 minutes at high temperature (e.g. 65-75° C. or about 70° C.). The pasteurization kills the microorganisms present in the apples and therefore increases the durability and lifespan of the resulting synthetic leather. The formation of apple paste can be performed with any suitable grinding means including mechanical grinding and the like. In preferred embodiments, the grinding is performed until the size of the solid apple residues is less than 200 microns, preferably less than 100 microns. In some embodiments, the ground apple or apple peels have a uniform size distribution and can have a D50 of between 50 and 60 μm. In some embodiments, at least 99% of the particles have a size less than 150 μm. In some embodiments, at least 90% of the particles have a size of less than 80 μm. This allows the elimination of additional steps that may be otherwise necessary. Indeed, traditional methods first dry the apple paste, then grind to obtain a dried powder and then re-suspend the powder. The method of the present disclosure advantageously does not require a drying step to obtain a powder and therefore does not include a resuspension step. Thus, in the present method, the apple paste and particularly apple peel is used directly in the mixture to produce the synthetic leather. This leads to a reduction in cost in the operation of the present method.

In some embodiments, apple peel is used to produce the mixture as opposed to entire apples or other parts of the apple. Apple peel is a waste obtained from the production of applesauce. Revalorization of this waste is thus an advantage of the present method. Moreover, using apple peel as opposed to the entire apple also has certain advantages and allows the production of a synthetic leather having improved properties. The apple peel is the component of the apple that is the richest in fibre (including cellulose, hemicellulose, pectin, β-glucans, gums, starch and lignin). This high fibre content provides more cellulose per weight than other parts of the apple. In addition, the apple peels are rich in Vitamin K, Vitamin A, Vitamin C, flavonoids, and red polyphenols. These antioxidants can act as preservatives of the synthetic leather. Using apple peel is also one way of including a higher concentration of waste (i.e. the apple peels) in the synthetic leather, achieving 35-50 wt. % of apple-based residue in the mixture and also 35-50 wt. % of apple-based residue derived contents in the synthetic leather.

The plasticizing agent in the mixture facilitates a crosslinking reaction between the cellulose of the apple-based residue and the polymer agent. This crosslinking allows the synthetic leather to have suitable physical properties such as mechanical strength and elasticity. The primary role of the plasticizing agent is to improve the flexibility and processability of the polymers by lowering the second order transition temperature, the glass transition temperature (Tg). The plasticizing agent generally increases the flexibility, workability, and/or distensibility of the synthetic leather by reducing the tension of deformation, hardness, density, viscosity and electrostatic charge of a polymer. Examples of plasticizing agents include glycerol, polyglycerol, starch, isosorbide, ethylene glycol (EG), diethylene glycol (DEG), triethylene glycol (TEG), polyethylene glycol (PEG), tetraethylene glycol, propylene glycol (PG), sorbitol, mannitol, xylitol, to name a few examples. The plasticizing agent can be a small organic molecule (e.g. molecular weight of less than 300 g/mol, preferably less than 250 g/mol and more preferably less than 200 g/mol) comprising a plurality of OH groups. The combination of glycerol as a plasticizing agent and PVA as the polymer agent is a preferred embodiment because of the synergistic OH groups present in both molecules. The plasticizing agent can be included in the mixture in a concentration of up to 35 wt. %, up to 30 wt. %, from 5 to 35 wt. %, from 5 to 30 wt. %, from 10 to 35 wt. %, from 15 to 35 wt. % or from 20 to 35 wt. %.

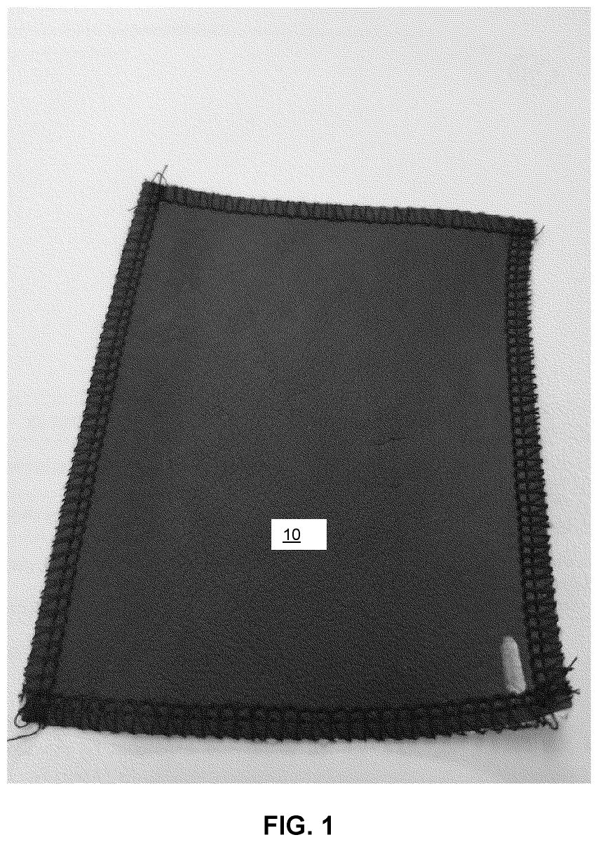

To obtain the synthetic leather, the mixture is formed and dried. When the apple-based residue is a dry powder, the synthetic leather can be obtain by extrusion. The mixture is prepared as a dry mixture or partially dried if glycerol is added. The polymer agent is first solubilized as described above and then mixed with the other components at the inlet of the extrusion device. The extrusion temperature can be selected based on the type of polymer agent. The temperature should be sufficiently high to render the polymer agent amorphous (or semi-liquid) but not too high to avoid degradation of the polymer agent. In one example, for PVA, the temperature is from 145 to 165° C. The mixture is then extruded into a film or any other desired shape. In some embodiments, the extrusion can be performed in two steps. First, granules are produced and then they are melted and extruded into a film. Subsequently, the film can optionally be calendered (for example using a metallic roller). In some embodiments, the roller has a textured surface to impart a desired motif on the surface of the leather. Finally, the leather can be laminated on a fabric, for example cotton, polyester, bamboo, rayon and the like. The synthetic leather can be formed into a variety of shapes, sizes and thicknesses, an example of such a synthetic leather is shown at 10 in FIG. 1. The formation of a free standing sheet of synthetic leather is known to the skilled person in the art, and methods of doing so include extrusion and coating methods. The drying can be performed at a temperature ranging from 45 to 65° C. In some embodiments, the drying is performed with a suction or vacuum to reduce the occurrence of air bubbles in the synthetic leather. In some cases, degassing additives may be included.

In some embodiments, the mixture further includes coloring pigments. The coloring pigments can be included in a concentration of up to 10 wt. %, for example from 1 to 10 wt. %. The coloring pigments may be agroalimentary waste such as a waste derived from coffee. Other examples of coloring pigments include but are not limited to carbon black, yellow-orange saffron, beetroot red, camphee black, carotenoids, tea, camomile, onions, indigo blue, madder lacquer red and the like.

The present synthetic leather is advantageously obtained in a method that has low usage of water and does not produce much waste. On the contrary, the method utilizes waste and turns the waste into the synthetic leather. The present synthetic is considered biobased according to the American Society for Testing Materials (ASTM) test D6866. The present leather is also considered biodegradable as assessed by ASTM D5864-11.

In some embodiments, a surface treatment with elastomers is performed on the synthetic leather obtained. Since a biosource is included in the making of the synthetic leather of the present disclosure, the synthetic leather will generally be porous. The surface treatment with an elastomer can homogenize the surface of the synthetic leather and fill the pores with elastomers. The surface treatment can also be used to impart additional properties to the leather for example water resistance. The surface treatment also helps improve the mechanical properties of the synthetic leather. In some embodiments, the elastomers form a surface of 3-7 microns on the synthetic leather. Additives can be incorporated in the elastomeric layer, for example anti-ultraviolet additives or coloring agents.

### EXAMPLE

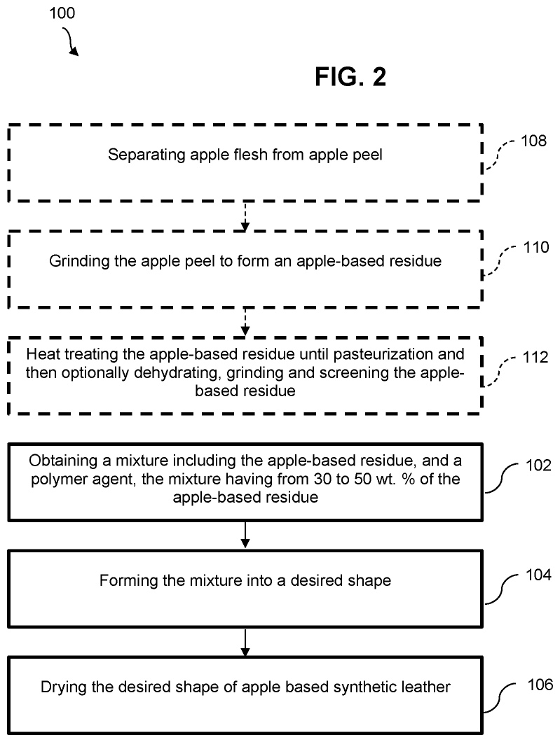

FIG. 2 shows an example of a method 100 of producing a synthetic leather 10 such as the one shown in FIG. 1. The following listing of method steps is meant to be exemplary only. For instance, in some other methods, additional steps can be added to the steps 102-106. Also, it is intended that the steps 108-112 are only optional. Accordingly, these steps can be omitted in some embodiments.

At step 102, a mixture is obtained. The mixture includes an apple-based residue and a polymer agent. More specifically, the mixture has from 30 to 50 wt. % of the apple-based residue.

At step 104, the mixture is formed into a desired shape. This step can include extrusion, coating, lamination, spin-coating, or a combination thereof.

At step 106, the desired shape is dried into the synthetic leather. In some embodiments, the step 106 of drying includes a step of heating the desired shape at a given temperature for a given period of time. In some other embodiments, the step 106 of drying can include the resting of the desired shape at ambient temperature for a given period of time. In some embodiments, the desired shape can be a free standing sheet which can may be rolled. In some embodiments, the desired shape is a sheet having a thickness of from 150 μm to 1 mm or preferably from 250 μm to 1 mm. The synthetic layer may be produced on a base layer which can be performed using lamination techniques.

In some embodiments, the method 100 includes a step 108 of separating apple flesh from apple peel. In these embodiments, the method 100 can include a step 110 of grinding the apple peel into an apple-based residue. It was found that the quality of the resulting synthetic leather is more desirable when the apple-based residue is made from apple peel rather than from a mixture of apple peel and apple flesh, or from apple flesh only. In these embodiments, the apple flesh resulting from such a separating step can be used to cook apple-based food such as juices, apple sauce, and the like. In some embodiments, the apple peel is obtained as a waste from the juice or sauce industry who performed the separation of peel and fresh, discarding the peel.

At step 112, the apple-based residue particularly when it is an apple paste is heat treated until pasteurization. More specifically, the apple-based residue can be heated, for instance in an industrial oven, up to a given temperature for a given period of time. In some embodiments, the apple-based residue is bought or otherwise supplied already pasteurized. Accordingly, the pasteurization step can be omitted. However, in some other embodiments, the apple-based residue may need to be pasteurized prior to performing the steps 102-106 of the method 100 to prevent undesirable degradation of the synthetic leather over time.

A first mixture was prepared with 30 wt. % of apple-based residue, 69 wt. % of polymer agent being Terratex™ FX1515 (a biodegradable polyester), and 1 wt. % of a coloring pigment being carbon black. The synthetic leather observed had suitable mechanical properties and was used to form a free standing sheet (see FIG. 1). Similar results were obtained with the second and third mixtures tested. The second mixture contained 40 wt. % of apple-based residue, 60 wt. % of Terratex™ FX1515 and 1 wt. % of carbon black. The third mixture contained 40 wt. % of apple-based residue, 30 wt. % of glycerol, 29 wt. % of Terratex™ FX1515 and 1 wt. % of carbon black.

Alternatively, the mixtures can be prepared without coloring pigments. A specific color may still be targeted by selecting a biopolymer and selecting a species of apple having a desired colour. Indeed, different apple species have various colours ranging from red to green.

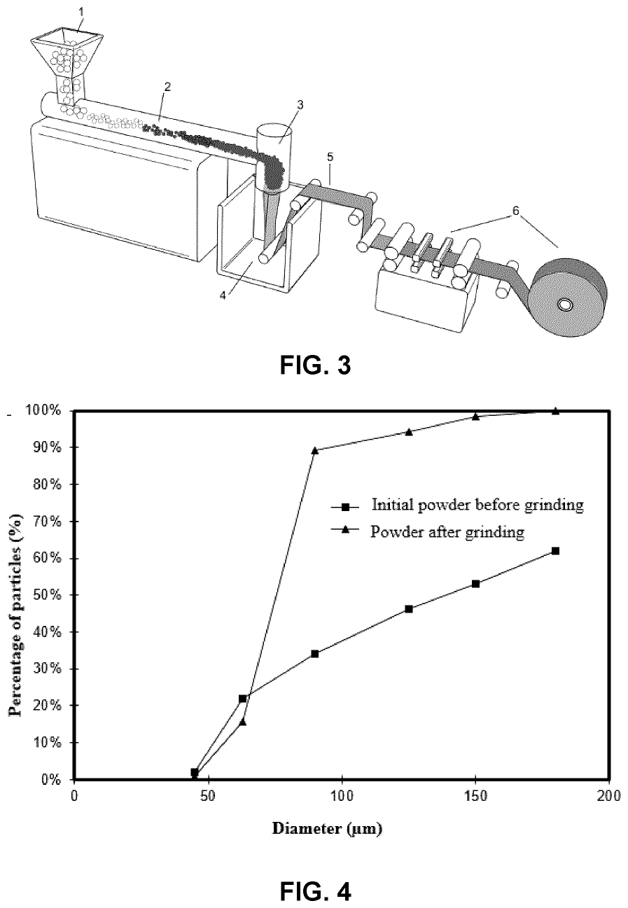

FIG. 3 shows a system for producing the synthetic leather by extrusion. The system has an inlet compartment 1 in which the dry components including the polymer agent and the apple-based residue are mixed. Although FIG. 3 illustrates a single inlet entry, in other embodiments, different inlet entries can be used for different components of the mixture. After the mixing at the inlet compartment 1, the mixture goes through a double screw section 2 to be homogenized. After homogenization, the mixture is formed or shaped in the extrusion section 3 of the system. Although FIG. 3 depicts a sheet, different shapes can be obtained by extrusion. Following extrusion, the sheet can be calendered 4 and then cooled 5 and dried 6 to be rolled into a roll of synthetic leather sheet. In some embodiments, the synthetic leather sheet can be laminated before being cooled 5.

The size distribution of the apple-based residue powder was evaluated before grinding and after grinding (FIG. 4). The apple-based residue was first dried to remove the humidity (Table 1), and then the particle size was measured. The ground powder which became a fine powder had 99% of its particles with a size of less than 150 microns and 90% of its particles with a size of less than 80 microns. On the other hand, 62% of the particles in the initial powder failed to pass through the screen of 180 microns.

TABLE 1
Humidity of the powders

| | | Humidity after |
|---|---|---|
| | Initial | drying at 85° C. |
| | humidity (wt. %) | for 1 day (wt. %) |
| Fine powder after grinding | 2.47 | 0.0 |
| Initial coarse powder | 7.47 | 0.0 |

Two mixtures with different additives (Citroflex™ versus polyethylene glycol (PEG)) were produced and used to make leather. The compositions are presented in Table 2.

TABLE 2
Compositions of two mixtures with Citroflex ™ or
PEG as additives

| | | Weight | Weight |
|---|---|---|---|
| | | percentage | percentage |
| | | in the first | in the second |
| Product | Function | mixture | mixture |
| Terratek ™ Flex | Bioplastic | 40 | 40 |
| GDH B1FA | | | |
| Apple powder | Filler | 30 | 30 |
| Glycerol (99% | Plasticizer | 20 | 20 |
| purity) | | | |
| Irganox ™ (1010 | Anti-oxidant | 0.5 | 0.5 |
| BMBcert) | | | |
| Irgafox ™ 168 | Stabilizer and | 0.5 | 0.5 |
| | secondary anti- | | |
| | oxidant | | |
| Aerosil ™ 200 | Fluidizing agent and | 0.15 | 0.15 |
| | anti-agglomeration | | |
| Citroflex ™ A4 | Secondary | 6.75 | 0 |
| | plasticizer | | |
| PEG | Secondary | 0 | 6.75 |
| | plasticizer | | |
| Carbon black | Colouring agent | 2-3 | 2-3 |

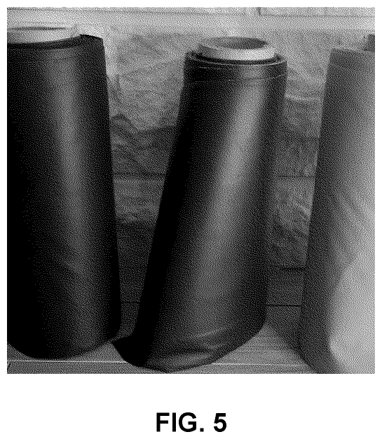

The mixtures presented in Table 2 were made into leather rolls (FIG. 5) by extrusion. An advantage of the present process is to perform a continuous extrusion which produces a long roll as opposed to a batch extrusion which produces sheets of smaller size which may then need to be combined. The extrusion parameters were as follows. A temperature of 100-130° C. in the feed zone, a temperature of 130-150° C. in the intermediate zone, a temperature at the nozzle of 140-170° C. and the cooling roller was at a temperature of 15-25° C. The temperature is closely monitored to avoid the degradation of the apple. The extrusion is performed slowly whereas the cooling is performed as fast as possible in order to yield a flexible leather film.

The humidity was measured to be 0.04% by Karl Fischer titration or to be 0.5% based on the loss of weight balance according to American Society for Testing and Materials (ASTM) D6890. To obtain such low humidity content, a drying for 4 hours was performed at 50° C.

The mechanical properties of the obtained leather was assessed according the American Society for Testing and Materials (ASTM) tests. The transmission of water vapour was assessed according to ASTM E96-E96M BW for 1 day. The abrasion resistance was assessed with ASTM D3884-09 (2017). The hydrostatic pressure (cm) was measured according to American Association of Textile Chemists and Colorists (AATCC) test AATCTM127-2017. The results of the present textile were compared to the properties of an animal based leather. The present apple based synthetic leather demonstrated superior properties as shown in Table 3.

TABLE 3
Properties of the apple based leather compared to animal leather

| | ASTM E96- | AATCTM127- | ASTM |
|---|---|---|---|
| Leather | E96M BW (1 d) | 2017 | D3884-09 |
| Animal | 2279 | 126 | 1459 |
| Apple | 372 | 348 | >2000 |

The thermal stability of the Terratek™ GDH and Terratek™ FX1515 as well as that of apple powder was confirmed by subjecting each to a temperature of 155° C. or 180° C. for 30 mins. After 30 mins, the mass loss of Terratek™ GDH was only 2.7% and 2.5% at 155° C. and 180° C. respectively. After 30 mins, the mass loss of Terratek™ FX1515 was only 7.9% and 3.8% at 155° C. and 180° C. respectively. Finally, after 30 mins, the mass loss of apple powder was only 5.1% and 7.5% at 155° C. and 180° C. respectively. All three thus showed good thermal stability suitable for extrusion.

The density of the apple based leather was measured to be 1.267 g/cm³ assessed by water displacement to measure the volume and a scale to measure the weight.

A final assessment was made on apple based leather to determine the content of volatile compounds. The Citroflex™ containing leather demonstrated a very low release of volatile mass (0.76%) at 118° C. confirming that the plasticizer is well integrated in the leather.

1. A method of producing a synthetic leather, the method comprising:
obtaining a mixture including an apple-based residue, and a polymer agent, the mixture having from 30 to 50 wt. % of the apple-based residue;
forming the mixture into a desired shape; and
drying the desired shape to obtain the synthetic leather.

2. The method of claim 1, wherein the apple-based residue is in powder form.

3. The method of claim 1, further comprising, before obtaining the mixture, heat treating the apple-based residue to pasteurize the apple-based residue.

4. The method of claim 3, further comprising, before the heat treating, grinding apples to produce the apple-based residue.

5. The method of claim 4, wherein grinding the apples comprises separating apple flesh from apple peel, and grinding the apple peel to form the apple-based residue.

6. The method of claim 5, wherein the apple peel is grinded without prior dehydration.

7. (canceled)

8. The method of claim 1, wherein the apple-based residue has particles of a size of less than 120 μm.

9. The method of claim 1, wherein the mixture includes from 35 to 45 wt. % of the apple-based residue.

10. The method of claim 1, wherein the mixture includes from 25 to 70 wt. % of the polymer agent.

11. The method of claim 1, wherein the mixture further includes up to 30 wt. % of a plasticizing agent.

12. The method of claim 1, wherein the plasticizing agent includes a primary plasticizer and a secondary plasticizer different from the first plasticizer.

13. The method of claim 1, wherein said forming includes extruding the mixture into the desired shape.

14. The method of claim 13, wherein the extruding comprises a first step of producing granules and a second step of melting and extruding the granules into the desired shape.

15. (canceled)

16. (canceled)

17. The method of claim 1, wherein the drying is performed under one of suction and vacuum.

18. (canceled)

19. The method of claim 1, wherein the mixture is free of at least one of polyurethane and polyvinyl chloride.

20. (canceled)

21. (canceled)

22. The method of claim 1, wherein the desired shape is a free standing sheet, the free standing sheet including a single layer of the mixture.

23. (canceled)

24. The method of claim 1, wherein the synthetic leather is produced on a base layer.

25. A mixture to be used for preparing artificial leather comprising from 30 to 50 wt. % of apple-based residue, from 25 to 70 wt. % of a polymer agent, up to 10 wt. % of a coloring pigment and up to 30 wt. % of a plasticizing agent.

26. The mixture of claim 25 wherein the apple-based residue is in powder form.

27. The mixture of claim 25 wherein the plasticizing agent includes a primary plasticizer and a secondary plasticizer different from the first plasticizer.
